(19) United States
(12) Patent Application Publication
(10) Pub. No.: US 2007/0094271 A1
(43) Pub. Date: Apr. 26, 2007

(54) Method and system for an enhanced subscription capability for a newsletter

(75) Inventors: Tamara Juschkova, Wiesloch (DE); Dirk P. Wagner, Schiffweiler (DE)

Correspondence Address: KENYON & KENYON LLP, 1500 K STREET N.W., WASHINGTON, DC, 20005, US

(73) Assignee: SAP AG

(21) Appl. No.: 11/361,973

(22) Filed: Feb. 27, 2006

Related U.S. Application Data
(60) Provisional application No. 60/728,896, filed on Oct. 21, 2005.

(51) Int. Cl. G06F 17/30

(52) U.S. Cl. 707/10

(57) ABSTRACT

A method and system are provided for an enhanced capability to subscribe to a newsletter through a network site. This capability may be implemented as part of a campaign using a customer relationship management (CRM) tool such as mySAP CRM®. As part of this enhanced capability, an email may be sent to a business partner containing a link to a network site allowing the business partner to easily subscribe to the newsletter. The link may contain an embedded identifier to indicate, for example, the marketing or sales campaign, the target group the business partner belongs to, and/or the business partner's identity to aid in gathering information about newsletter interest and campaign effectiveness. The business partner may also or alternatively be presented a link on the publisher's network site allowing the business partner to subscribe to a newsletter.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates to a method and system for an enhanced subscription capability for a newsletter through a newsletter publisher's network site that may be part of a marketing or sales campaign initiated by the publisher according to one embodiment of the present invention.

### BACKGROUND

A newsletter is one means by which a business maintains contact with its business partners—the business's potential and actual customers as well as other interested parties. A newsletter may contain articles, product information, tips, etc. and may allow the newsletter publisher (i.e., the business) to provide valuable information to its partners while maintaining an ongoing relationship. In addition to newsletters targeting business partners, a newsletter may also be internally directed at employees and others. The use of newsletters is an effective communication tool to define a publisher's message, disseminate information, maintain ongoing relationships, and to develop new relationships.

Business partners typically subscribe to a newsletter by visiting a publisher's network site and affirmatively entering the required subscription information. This requires a positive act on the part of the business partner and assumes that the business partner is aware of the newsletter and where and how to subscribe. Using customer relationship management software, a publisher may be able to derive statistics related to the newsletter subscriptions and interests of particular types of business partners. In particular, if business partners provide additional information about themselves and their interests during the subscription registration, this process is further enhanced. However, the disjointed process whereby business partners subscribe to newsletters and the marketing and sales activities of the publisher make this information useful but less than ideal.

The present invention provides a novel means for enhancing the subscription process by providing an additional capability to the publisher and the publisher's network site to facilitate the subscription process and to link the process of subscribing to the publisher's marketing and sales activities.

### BRIEF DESCRIPTION OF THE DRAWINGS

FIG. 1 is a diagram illustrating the network environment in which the enhanced subscription capability is provided for a publisher's newsletter according to one embodiment of the present invention.

FIG. 2 is a flowchart describing the newsletter subscription process according to one embodiment of the present invention.

FIG. 3 is a screen shot of an example subscription registration page on a network site for a newsletter according to one embodiment of the present invention.

FIG. 4 is a screen shot of an example login page for a network site according to one embodiment of the present invention.

FIG. 5a is a screen shot of one portion of a business partner registration page on a publisher's network site according to one embodiment of the present invention.

FIG. 5b is a screen shot of a second portion of a business partner registration page on a publisher's network site according to one embodiment of the present invention.

FIG. 5c is a screen shot of an example registration confirmation page for a successful business partner registration with a publisher on a publisher's network site according to one embodiment of the present invention.

FIG. 6a is a screen shot of the interests tab in a business partner profile page of a publisher's network site according to one embodiment of the present invention.

FIG. 6b is a screen shot of the subscriptions tab in a business partner profile page of a publisher's network site according to one embodiment of the present invention.

FIG. 7 is a screen shot of a newsletter included in an email to a business partner according to one embodiment of the present invention.

FIG. 8 is a block diagram illustrating the platform on which the method and system for an enhanced subscription capability for a newsletter using a publisher's network site may operate according to one embodiment of the present invention.

### DETAILED DESCRIPTION

A method and system are provided for an enhanced capability or process to subscribe to a newsletter through a newsletter publisher's network site according to one embodiment of the present invention. This enhanced capability may be implemented as part of a publisher's marketing or sales campaign using a customer relationship management (CRM) tool such as mySAP CRM® in one embodiment of the present invention. As part of this enhanced capability, an email may be sent to a business partner, such as for example a customer, potential customer, supplier, and/or employee according to this embodiment. The email may contain a link to a publisher's network site allowing the business partner to easily subscribe to the newsletter. The link may contain an embedded identifier to indicate, for example, the marketing or sales campaign, the target group the business partner belongs to, and/or the business partner's identity allowing for the rapid tracking of marketing or sales campaign statistics and business partner interests in addition to the email informing the business partner about the newsletter and providing an expedited ability to initiate the process to subscribe to the newsletter using the link. In an alternative embodiment of the present invention, the business partner may be presented a link on the publisher's network site allowing the business partner to subscribe to a newsletter. This publisher's network site link may also be offered as part of a marketing or sales campaign or may be presented independent of such a campaign in various embodiments of the present invention. The link on the publisher's network site may also contain an embedded identifier to also indicate, for example, the marketing or sales campaign, the target group the business partner belongs to, and/or the business partner's identity also allowing for the rapid tracking of statistics related to the campaign, business partner interests, and response to the newsletter.

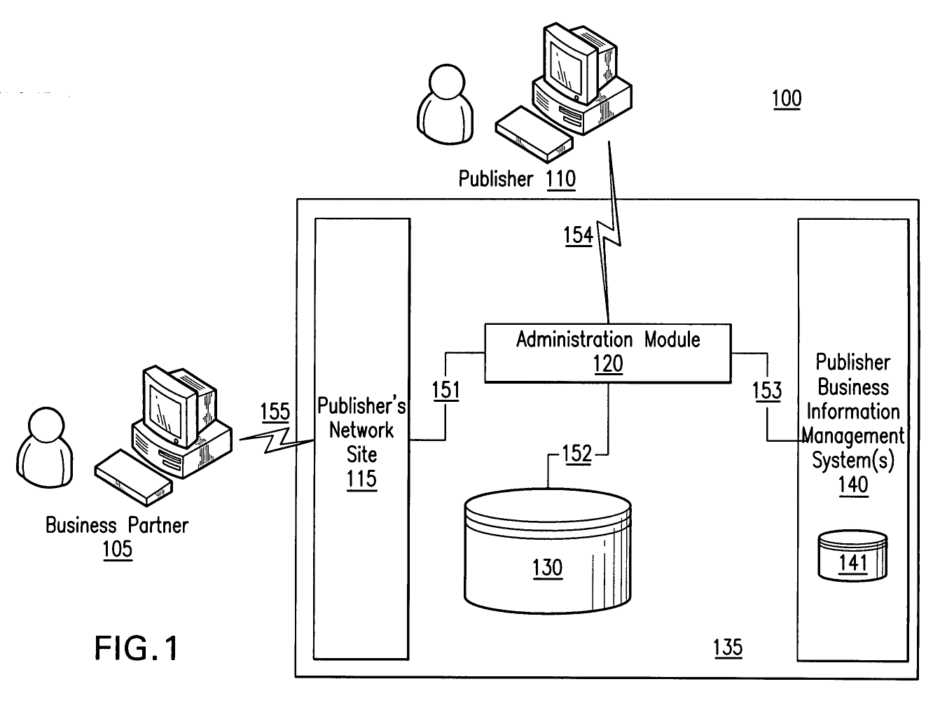

FIG. 1 is a diagram illustrating the network environment in which the enhanced subscription capability is provided for a publisher's newsletter according to one embodiment of the present invention. A publisher 110 is a business or other entity that produces an electronic newsletter and makes the newsletter available to potential subscribers 105 over a communication network 154, 155. The potential subscribers 105 are termed business partners 105 herein and may include existing customers of the publisher 110, prospective new customers, suppliers, employees, and any other group the publisher may want to target for the dissemination of information. The network 154, 155 may include any communications network including a wide area network (WAN), local area network (LAN), a satellite network, a wireless network, and the Internet and it provides the electronic connectivity between a business partner 105 and a publisher 110 and between the different components of the publisher's network system 100. This embodiment of the present invention relates to the process of subscribing to a newsletter.

A newsletter contains a collection of personalized articles and provides ongoing communication with a target group. For example, a product newsletter provides ongoing contact with the customers who have already purchased a product. An employee newsletter provides ongoing contact with the employees in a department or within an entire organization. Newsletters are generally distributed through email though they may also be distributed by other means such as, for example, hardcopy by mail, fax, etc. Newsletters are published periodically either at a given interval (e.g., monthly) or due to a particular event (e.g., on the release of a software revision). The publisher 110 may create a newsletter using any of the publisher's hardware and/or software products. In one embodiment, a newsletter once created may be stored in a publisher's business information management system(s) 140 and made available to a publisher's network site 115 for display to business partners 105. The publisher's information technology hardware environment 135 contains the servers on which the publisher's network site 115, business information management system(s) 140, administration module 120, and associated databases 130, 141 are stored and on which they run. For example, the administration module 120 may consist of one or more software applications, programs, modules, procedures, or other computer code to include firmware and may additionally include data that resides on one or more servers, computers, or other hardware platforms that make up the publisher's information technology hardware environment 135. The administration module 120 may handle the publisher's interaction 154 with the newsletter subscription and dissemination system 100 and may contain specific functionality for the management of the marketing or sales campaigns for these newsletters. The business partner interaction 155 with the newsletter subscription and dissemination system 100 is handled through the publisher's network site 115 which may serve as a portal to the both the administration module 120 and the publisher's business information management system(s) 140. The administration module 120 though shown as a separate entity may be a part of the publisher's network site 115 or the publisher's business information management system(s) 140. In addition to the databases 141 that are part of the business information management systems 140, the administration module 120 and the network site 115 may also use a local database 130 to store newsletter and subscription information.

The administration module 120 may communicate 152 with the local database 130; communicate 153 with the publisher's business information management system(s) 140; and communicate 151 with the publisher's network site 115 using a communication network that is part of the publisher's information technology hardware environment 135. In addition, direct communication (not shown) between the publisher's network site 115 and the publisher's business information management system(s) 140 may also occur. For example, the publisher's network site 115, administration module 120, local database 130, and business information management system(s) 140 may be located on servers and/or other computers that are part of a communication network—such as a local area network (LAN) or wide area network (WAN)—controlled by the publisher 110. In an alternative embodiment, the publisher's information technology hardware environment 135 may include a communication network that is shared by the publisher 110 and other network users. For example, the publisher's network site 115, administration module 120, local database 130, and business information management system(s) 140 may be located on servers and/or other computers that are part of at least one internal publisher communication network (e.g., a LAN and/or WAN) as well as a shared (i.e., shared by publisher with other non-publisher related entities) communication network such as the Internet. In either embodiment regardless of the network used for communication between the elements of the newsletter subscription and dissemination system 100, publisher communication 154 and business partner communication 155 with the newsletter subscription and dissemination system 100 may occur over an external network (i.e., a network external to the publisher 110 and not under the publisher's direct control), such as for example, the Internet. In an alternative embodiment, publisher and business partner communication 154, 155 with the newsletter subscription and dissemination system 100 may occur over a publisher-controlled network (such as a publisher-controlled wide area sales network) and/or may involve a combination of at least one publisher-controlled network and at least one external network.

The newsletter subscription and dissemination system 100 integrates a publisher's business information management systems(s) 140, which may serve as a backend system(s), with a publisher's network site 115, serving as a front-end system, and it 100 may use an administration module 120 in order to provide newsletter subscription and dissemination services to the publisher 110 and the business partner 105 according to one embodiment of the present invention. A publisher's business information management system 140 is an application with at least one associated database 141 typically using a database management system (DBMS) that provides data storage and associated programming support for that data (e.g., a query system such as an SQL editor, optimization routines, program interfaces). For example, a publisher may have a customer relationship management system 140 with its own database 141 developed using mySAP CRM® on the SAP® R/3 DBMS platform as one example of a business information management system 140.

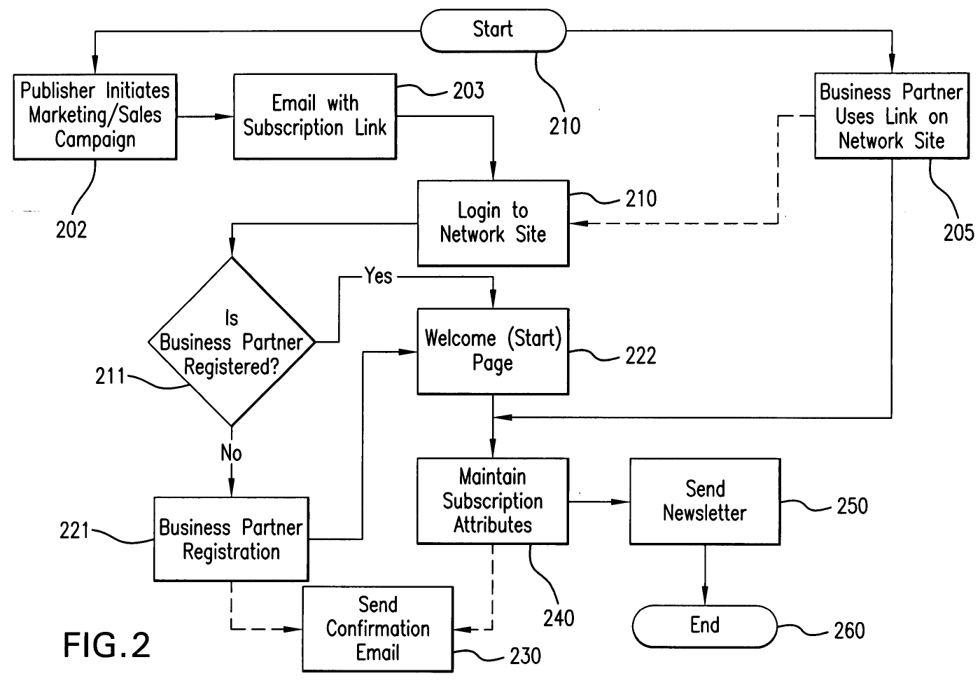

FIG. 2 is a flowchart describing the newsletter subscription process according to one embodiment of the present invention. The process begins 201 by providing a link (e.g., a hyperlink) to a business partner 105. The link may be provided as part of a purchaser's marketing or sales campaign where information about the newsletter including a link to subscribe to the newsletter is made available to a business partner 105 due to that business partner meeting the criteria of the target group for the marketing or sales campaign. The marketing campaign or sales campaign (used interchangeably herein and also referred to as the campaign) refers to any effort to target or present information to a group of one or more business partners which may include the marketing of products and/or services, offers for sale, promotions, providing product updates and pointers, etc. The target group for the campaign may be selected using known customer relationship management (CRM) tools and functions such as those available using mySAP CRM®. In another embodiment (not shown) the link may be provided independent of a campaign. For example, if a business partner 105 registers with a publisher 110 on the publisher's network site 115 for a reason unrelated to subscribing to a newsletter (e.g., when a business partner 105 purchases goods or services from the publisher 110), the business partner registration may initiate the providing of the link to the business partner 105 independent of a campaign.

The link may be a hyperlink or other navigation shortcut that when selected (e.g., clicking on the hyperlink) navigates the business partner 105 to, for example, the publisher's network site 115 to facilitate the subscription process according to one embodiment of the present invention. The link itself may be presented to the business partner 105 in various ways in different embodiments of the present invention. In addition to containing navigation information identifying, for example, the publisher's network site 115 and perhaps a specific page on the network site 115, the link may contain one or more embedded identifiers that allow greater detail to be provided to the publisher 110. For example, an embedded identifier containing a global user identifier (GUID) uniquely identifying a business partner 105 may be used in conjunction with stored business partner details (e.g., industry, interests, etc.) to gauge the interest in the newsletter (e.g., 80% of the interest in the newsletter came from hardware makers and only 10% came from software makers with 10% in other industries). The embedded GUID may instead of just uniquely identifying a business partner 105 may uniquely identify a business partner 105 as part of a target group for the campaign by including campaign identification information in the GUID. Alternatively, the campaign identification information may be a separate embedded identifier either embedded in conjunction with business partner identifier or instead of a business partner identifier. The embedded campaign identifier may be used to evaluate the effectiveness of a particular campaign (e.g., 14 of 19 business partners in the target group subscribed to the newsletter) and/or the association (matching of interest) between the target group and the newsletter. Other embedded identifiers and/or other identification information in a particular embedded identifier may also be included in other embodiments of the present invention.

In one embodiment, the link may be included as an object embedded in an email (i.e., an electronic mail message). In this embodiment, the publisher 110 initiates a marketing or sales campaign 202 using a CRM system 140 that may be one of the publisher's business information management systems 140. As part of generating the campaign, the publisher 110 may define a target group for the campaign using the CRM tools. An email may be sent 203 to the business partners 105 that make up the target group. This email may include various types of information such as, for example, a sample copy of the newsletter being promoted by the campaign. Other types of information may include, for example, offers for products and services, reminders about warranty periods, recalls, newly available upgrades or accessories, etc. The campaign may promote a newsletter using an opt-out or an opt-in distribution scheme. In an opt-out distribution scheme for the campaign, the business partners 105 forming the target group are automatically subscribed to the newsletter and must opt-out (i.e., cancel the subscription). In an opt-in distribution scheme for the campaign, the business partners 105 forming the target group must affirmatively complete a subscription process to become subscribed for the newsletter. The link will conform to the newsletter distribution scheme for the campaign. For example, if an opt-out distribution scheme is being used for a campaign, the link will facilitate the process of opting-out and cancelling the subscription of the business partner 105. If an opt-in distribution scheme is being used for a campaign, the link will facilitate the process of opting-in or subscribing the business partner 105 for the newsletter.

In another embodiment, the link may be displayed 205 to a business partner 105 on the publisher's network site 115. This network site link 205 may be displayed as part of a campaign or independently as stated above but instead of sending the link to a business partner 105 in an email 203, the link is provided to a business partner 105 when they next login to or visit the publisher's network site 115. In other embodiments of the present invention (not shown), the link may be displayed to the business partner 105 using other means.

Regardless of how the link is presented to the business partner 105, selecting the link (e.g., by clicking on the hyperlink) may result in connecting the business partner 105 with the publisher's network site 115 to allow the appropriate selection of a subscription option (e.g., unsubscribing in an opt-out distribution scheme campaign or subscribing in an opt-in distribution scheme campaign). Connecting the business partner 105 with a network site 115 to facilitate the subscription process (this step is not shown in FIG. 2) may present the business partner 105 with information about the newsletter and subscription options according to one embodiment of the present invention. In another embodiment, the business partner 105 may be directly presented with a login screen 210 on publisher's network site 115 (described below).

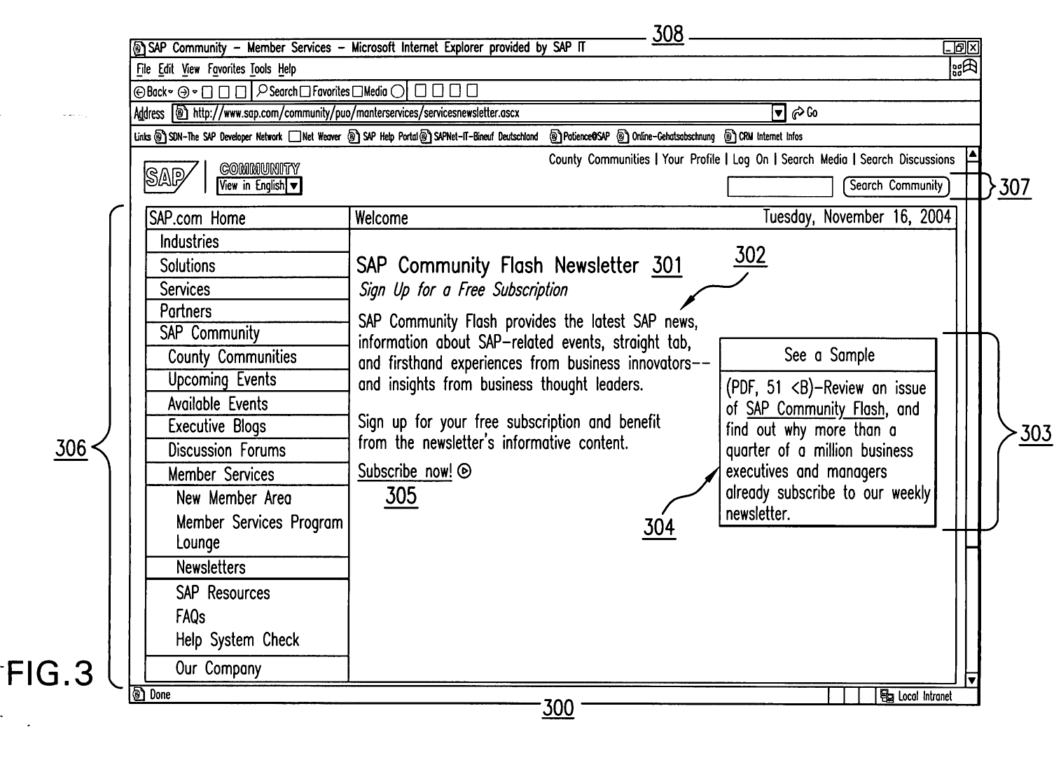

FIG. 3 is a screen shot of an example subscription registration page on a network site for a newsletter according to one embodiment of the present invention.

The subscription registration page 300 in this example embodiment is an Internet Web page displaying a newsletter title 301 identifying the newsletter, a newsletter description 302, and a sample issue offer 303 including a link 304 to a sample issue of the newsletter that the business partner 105 may review. In the example shown in FIG. 3, the SAP® community newsletters subscription registration page 300 is shown allowing a business partner 105 to subscribe to the “SAP Community Flash Newsletter” 301. The information presented 301-304 in the subscription registration page 300 is only one example of the content that may be included on the subscription registration page 300 which may contain none, some, or all of these fields along with other information in various embodiments of the present invention. In addition to this information, a subscription registration page 300 may also include a “Subscribe now!” (or other titled) link 305 or other option selection means such as, for example, a button (not shown) or pull-down menu option (not shown) allowing a business partner 105 to continue with the subscription registration process according to this embodiment. The business partner 105 may view the information presented in the subscription registration page 300 and decide whether to continue with the process by selecting the subscription link 305 or the business partner 105 may abort the process by exiting or navigating out of the subscription registration page 300. In addition to the newsletter information presented, other links 306, a search capability 307, and other network or network site navigation tools 308 may also be included on the subscription registration page 300 for the news letter.

Continuing with the newsletter subscription process shown in FIG. 2, a business partner 105 may need to login 210 to a publisher's network site 115 before the business partner 105 may access a newsletter or newsletter options according to one embodiment of the present invention. The login 210 step may be necessary to verify a business partner's identity with a publisher 110 before the business partner 105 is provided access to subscription and other newsletter options through the publisher's network site 115. An already registered business partner 105 may be able to login 210 on the publisher's network site 115 using the already registered identifier and password for the business partner 105 according to one embodiment of the present invention. A publisher's network site 115 may be able to implement known hardware or software recognition means for business partner verification. A new, unregistered business partner 105 may be presented a registration option allowing the business partner 105 to register with the publisher 110 on the network site 115.

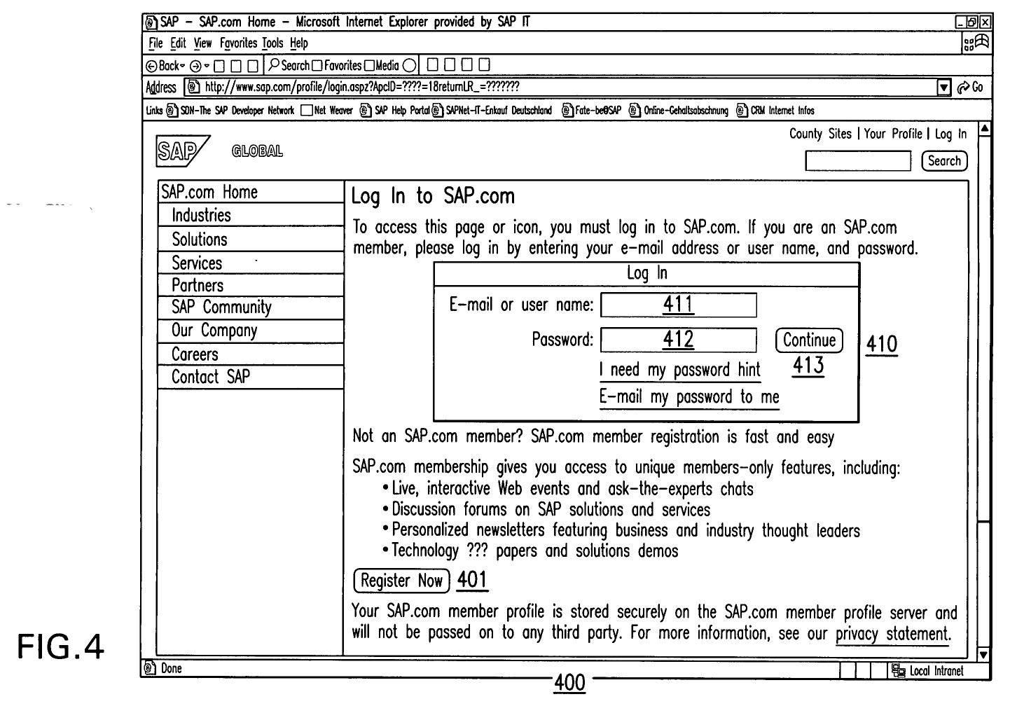

FIG. 4 is a screen shot of an example login page for a network site according to one embodiment of the present invention. The login page 400 may include login certification fields 410 such as, for example, an identifier field 411 and a password field 412 that may be used to verify a business partner's identity on the publisher's network site 115. The identifier field 411 may allow a business partner 105 to enter a unique identification such as an email address or user name as indicated in FIG. 4. The password field 412 allows the business partner 105 to verify his/her identity as the rightful user of the entered identifier. Once the appropriate business partner information is entered into login certification fields 410, the business partner 105 may select (e.g., by clicking on) the continue option indicated in this embodiment by a “Continue” button 413. The continue option may alternatively be selected using other means such as, for example, drop-down menu options (not shown) and hitting the “Enter” key while the highlight (i.e., cursor) is in one of the login certification fields 410, 411, 412. If a business partner 105 is not registered with a publisher's network site 115, a registration option may also be provided on the login page 400 as indicated in this example by the “Register Now” button 401. A business partner 105 may select this option to register with the publisher's network site 115.

If a new, unregistered business partner 105 selects the registration option 401 from the login page 400 on the publisher's network site 115, a business partner registration 221 process begins where the new business partner 105 provides publisher specified information in order to register with the publisher 110 and the publisher's network site 115. This information may contain identification information to verify a business partner's identity on subsequent logins. The registration information may also contain optional business partner demographic data and/or information on the interests of the business partner which may be used to tailor the information provided to the business partner 105 and enhance customer relationship management reporting for the publisher 110 and the publisher's network site 115. Additionally, the registration information may include business partner contact information such as, for example, one or more email addresses and/or facsimile machine (fax) numbers so that the publisher may be able to contact the business partner and send information to the business partner including newsletters.

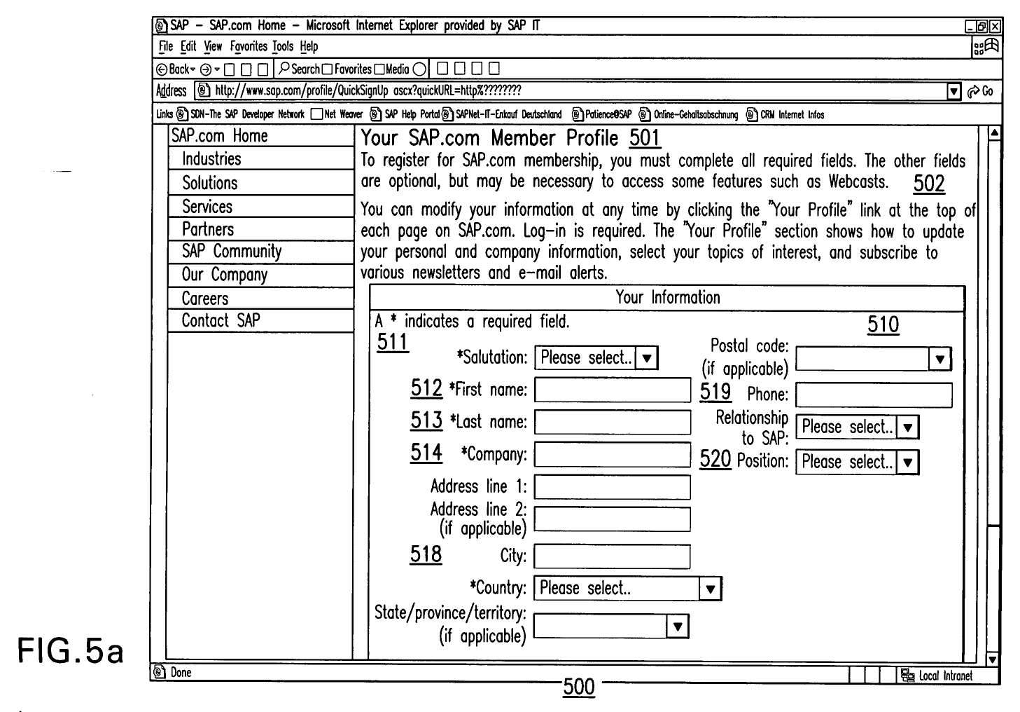

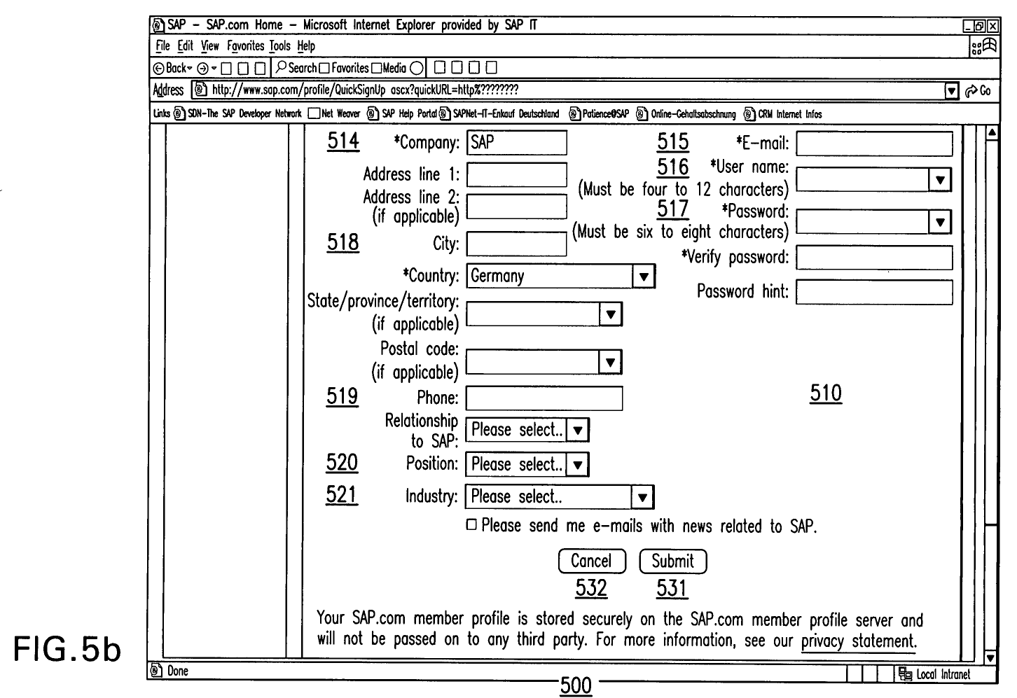

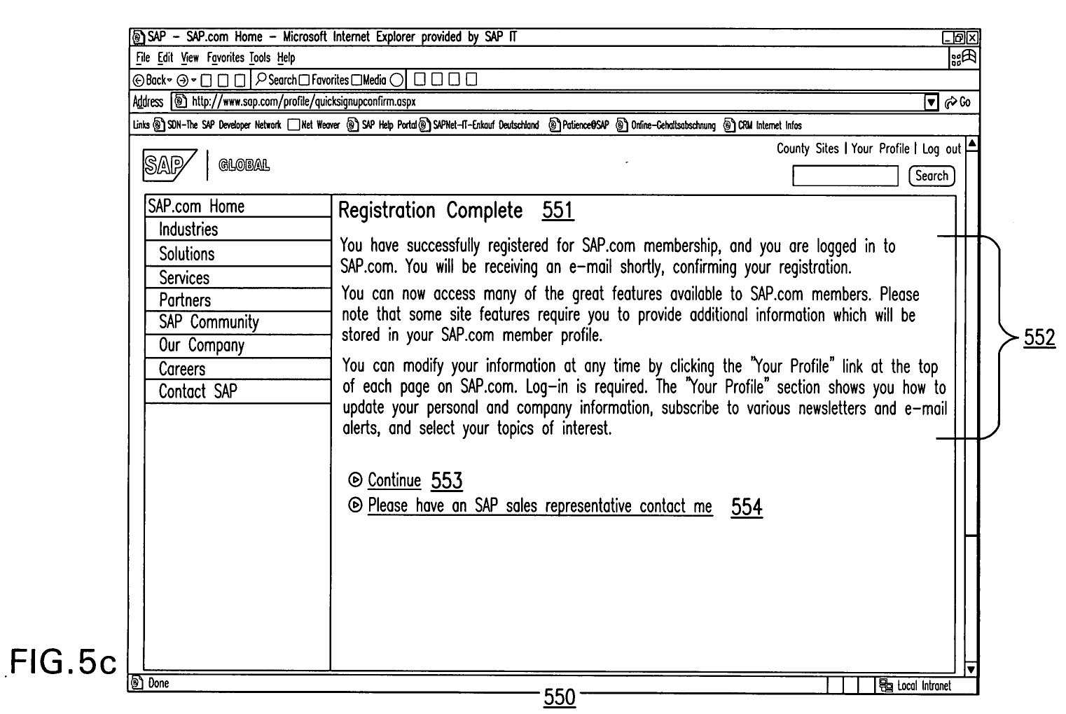

FIG. 5a is a screen shot of one portion of a business partner registration page on a publisher's network site according to one embodiment of the present invention. FIG. 5b is a screen shot of a second portion of a business partner registration page on a publisher's network site according to one embodiment of the present invention. The business partner registration page 500 (shown in its entirety through portions displayed in both FIGS. 5a and 5b) contains a title 501 and some limited instructions and/or description 502 that instruct the business partner 105 about completing the registration information form 510 contained on the page 500. Only the top portion of the registration information form 510 is shown in FIG. 5a while the bottom portion of the registration information form 510 is shown in FIG. 5b with some overlap between the fields on both forms. The fields on the registration information form 510 may allow the entry of information required by a publisher 110 as well as optional information that a business partner 105 may choose to provide. For example in FIGS. 5a and 5b, the fields preceded by an asterisk (“*”) are the mandatory or required fields as indicated in a notation 511 on the registration information form 510. The fields not preceded by an asterisk (“*”) are optional and allow the business partner 105 at his/her discretion to provide additional information to the publisher 110 during the registration process. This additional information may be used by the publisher 110 in tailoring the display and/or targeting of information and offers to the business partner 105 as well as for the enhanced compilation of statistics relating to customer relationship management and/or network site statistics. Examples of required fields in the embodiment shown in FIGS. 5a and 5b include a business partner first name 512, last name 513, company 514, email address 515, user name 516, and password 517. Either the user name 516 and the email address 515 may be used as the business partner identification in the identifier field 411 on the login page 400 of the network site 115 as shown in FIG. 4 discussed above with the password 517 providing the verification of the business partner identity as discussed above according to this embodiment. Examples of optional fields in the registration information form 510 shown in FIGS. 5a and 5b include city 518, phone number 519, position 520, and industry 521. The field values for the position 520 and industry 521 fields use drop down menus to allow selection from a pre-designated list of allowable entries according to this embodiment. Once the business partner 105 has completed entering the registration information, he/she 105 may submit 531 (by selecting the submit option indicated by the “Submit” button 531) the registration information to the publisher 110 to generate a business partner account or to otherwise register the business partner 105 with the publisher 110 and/or the publisher's network site 115. If the submitted 531 registration information is not complete—i.e., values are not entered in all the required fields and/or incorrect values are provided in some of the field data-an error may be provided and the business partner 105 may be asked to fix the problems before continuing. The business partner 105 may at any time during the registration process decide to abort the process by selecting the cancel option indicated by the “Cancel” button 532 in FIG. 5b.

On the successful submission of registration information by a business partner 105, the publisher's network site 115 may display a registration confirmation to the business partner 105. FIG. 5c is a screen shot of an example registration confirmation page for a successful business partner registration with a publisher on a publisher's network site according to one embodiment of the present invention. The registration confirmation page 550 may include a title 551 and a description 552 indicating that the business partner registration is successful. The business partner 105 may be presented with an option to continue 553 indicated by the “Continue” button 553 which allows the business partner 105 to access the publisher's network site 115 as if the business partner 105 just successfully logged in 210. The business partner 105 may also be presented with other options such as, for example, an option 554 to have the publisher 110 contact the business partner 105. In addition to or instead of the display of a registration confirmation page 550 and as indicated in FIG. 2, a business partner 105 may also be notified of a successful registration by an confirmation email 230 sent to the business partner using the “E-mail” field 515 value (as shown in FIG. 5b) entered by the business partner 105 during the registration process.

Once a new, previously unregistered business partner 105 successfully registers 221 with the publisher 110 on the publisher's network site 115, a welcome or start screen (not shown) may be displayed 222 for the business partner 105. An already registered business partner 105 who logs-in 210 to a publisher's network site 115 as described above may also be presented a welcome or start screen (not shown). This welcome or start screen may include general information related to the publisher 110, the publisher's network site 115, and/or may contain particular information directed to the business partner 105 either individually or as part of a group of business partners sharing one or more particular characteristics (e.g., all business partners located in the Federal Republic of Germany). In this embodiment, the welcome or start page serves as an introductory page to the publisher's network site 115. From this welcome or start page, a registered business partner 105 may navigate the publisher's network site 115 to reach the newsletter options including which newsletters a business partner is subscribed to. For example, the newsletter options such as newsletter subscriptions may be contained in the profile information of the business partner 105. In an alternative embodiment of the present invention, the welcome or start screen (not shown) is a brief welcome to the network site 115 using, for example, a popup window, after which the business partner 105 is directed to their profile information from which newsletter subscription options may be modified.

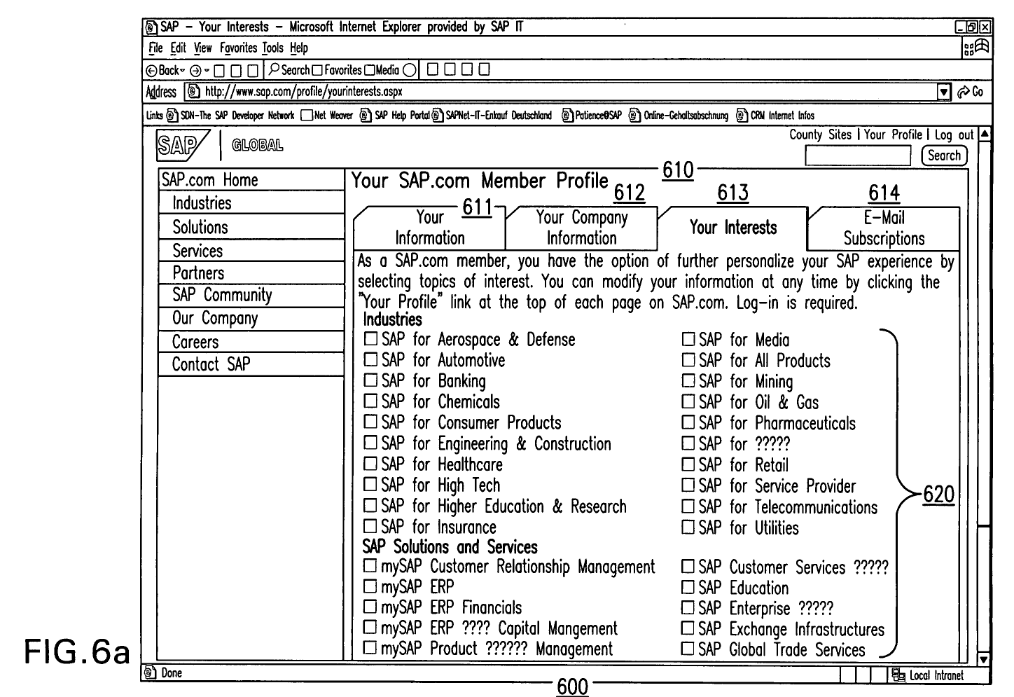

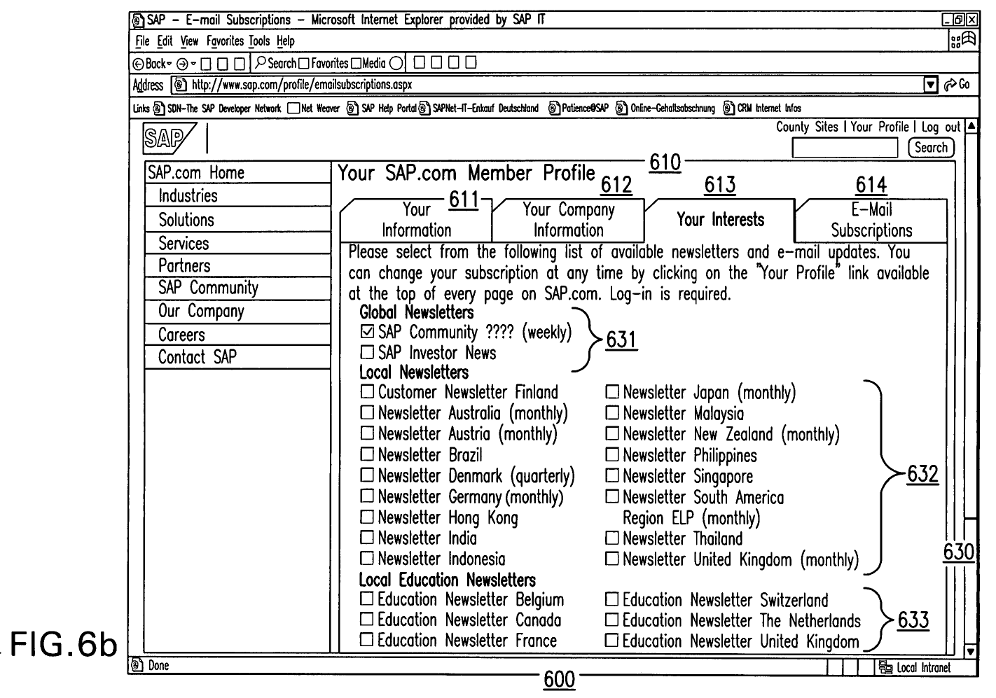

As stated above, the subscription attributes or information for a business partner 105 may be maintained 240 in the newsletter subscription process shown in FIG. 2 using the profile information for the business partner 105 on the publisher's network site 115. FIG. 6a is a screen shot of the interests tab in a business partner profile page of a publisher's network site according to one embodiment of the present invention. The business partner profile page 600 contains a table 610 with multiple tabs containing the specific information affiliated with a particular business partner 105 according to this embodiment. For example, the table 610 shown in FIG. 6a contains four tabs: “Your Information” 611, “Your Company Information” 612, “Your Interests” 613 shown, and “E-mail Subscriptions” 614. The interests tab 613 allows a business partner 105 to indicate topics of interest by checking the appropriate boxes. The interests 620 indicated by the business partner 105 may be used by the publisher 110 to tailor the display of information to the business partner 105 on the publisher's network site 115 as well as to determine what information is sent to the business partner 105 either electronically and/or in hardcopy format. FIG. 6b is a screen shot of the subscriptions tab in a business partner profile page of a publisher's network site according to one embodiment of the present invention. The business partner profile page 600 shown in FIG. 6b is the same as FIG. 6a and contains a table 610 with four tabs—“Your Information” 611, “Your Company Information” 612, “Your Interests” 613, and “E-mail Subscriptions” 614—except that instead of the interests tab 613 being shown as in FIG. 6a the subscriptions tab 614 is instead displayed. The business partner 105 may select newsletters 630 by checking the appropriate boxes for the desired newsletters. The newsletters 630 may be organized by category 631-633 such as, for example, the “Global Newsletters” 631, “Local Newsletters 632, and “Local Education Newsletters” 633 categories shown in FIG. 6b. An option may also be presented (not shown) to select an entire category of newsletter at one time according to one embodiment of the present invention.

The last steps in the newsletter subscription process shown in FIG. 2 begin after the business partner 105 indicates his/her desired newsletters. The subscribed to newsletters 630 may be sent 250 to the business partner 105 using an appropriate means. As previously stated, email may be a common means of distributing a newsletter but other means such as fax, mailed hardcopy, network site availability, etc. may also be used. The delivery of the subscribed to newsletter(s) ends 260 the newsletter subscription process which may be used repeatedly by a business partner 105 to update and change their subscription preferences. The process outlined above refers to an opt-in newsletter distribution scheme. The same process may also be used in an opt-out newsletter distribution scheme with the maintain subscription attributes step 240 used to opt-out of a newsletter subscription and the send step 250 instead not sending the newsletter to the business partner 105. In an alternative embodiment of the present invention, a business partner may access one or more newsletter features and/or subscribe to a newsletter without needing to be registered with the publisher 110 on the publisher's network site 115. According to this embodiment, the log in step 210 and the registration step 221 may both be removed from the process with the business partner 105 navigating directly to the newsletter options page.

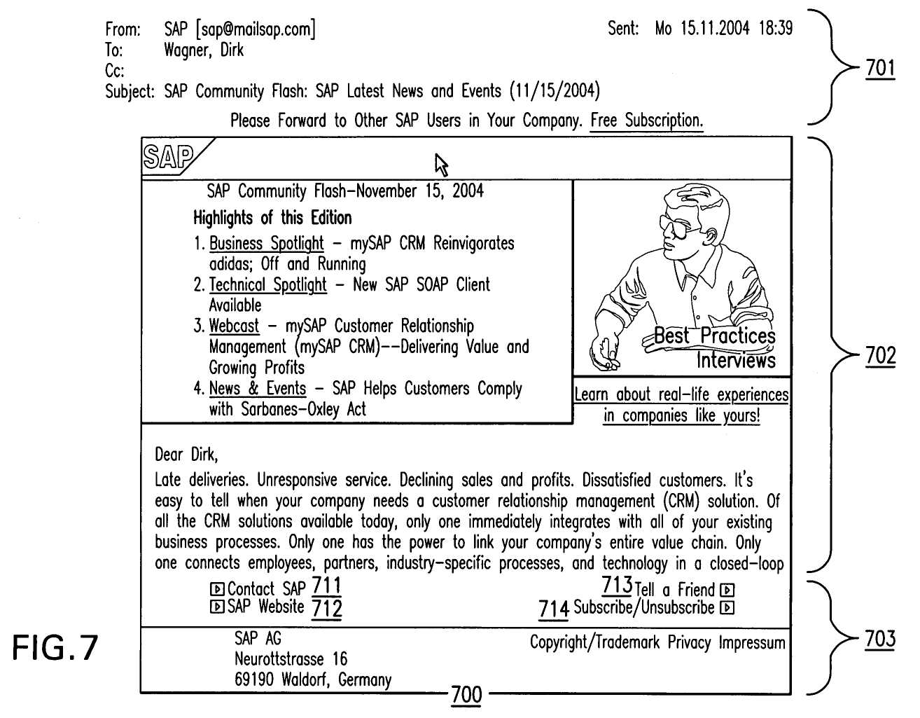

FIG. 7 is a screen shot of a newsletter included in an email to a business partner according to one embodiment of the present invention. The email header 701 identifies the email 700 routing information. The newsletter 702 (partially shown) is included in the body of the email 700 with links 703 provided to facilitate the implementation of various options related to the newsletter according to this embodiment. These options 703 may allow a business partner 105 to contact 711 the publisher 110 such as, for example, by means of an email message or by navigating the business partner 105 to the publisher's network site 115. The business partner 105 may also be presented with a link allowing for the quick navigation 712 to the publisher's network site 115. Another option may allow a business partner 105 to share 713 the newsletter and information about the newsletter with other business partners 105 (e.g., email addressees). For example, the “Tell a Friend” option 713 may forward the email 700 to another business partner 105. The subscribe/unsubscribe option 714 has already been discussed above. These options 703 are only some of the examples of the options that may be included with the newsletter according to this embodiment of the present invention.

Embedding a subscription link during the creation of a newsletter or when providing a link to a business partner (e.g., during the generating of an email to a business partner) may be performed by a publisher independent of any location on the publisher's network site and/or independent of the subscribe/unsubscribe process or mechanism used by the publisher according to one embodiment of the present invention. A subscription link or link (as referred to herein) may allow a business partner to subscribe and/or unsubscribe to a newsletter and may also contain embedded information used in CRM or as part of a marketing campaign as previously discussed. According to this embodiment, a link option may be provided to a publisher 110 creating a newsletter to bring a link into the newsletter without requiring the publisher to specify the URL or link information. This link option, when selected, may generate and/or copy the appropriate link within a newsletter for the newsletter publisher 110. For example, this link option may be made available to a publisher 110 creating a newsletter through the administration module 120 of the newsletter subscription and dissemination system 100. The link option may be presented, for example, as a button or pull-down menu option that when selected by the publisher embeds the link (e.g., the URL location) within the newsletter at a designated position. A link option may also or alternatively be provided to a publisher 110 initiating a subscription process, such as for example shown in FIG. 2, where the link is presented to a business partner 105. For example, a publisher 110 may include a link in an email on the publisher's network site 115 to facilitate a business partner 105 opting-in or opting-out of a newsletter subscription. The link option allows, for example, a marketing person working for the publisher 110 to include the link information without having to maintain the link which may be handled by a information systems support person or team working for the publisher. In this manner, the maintenance of the newsletter link information may be separated from the newsletter generation and/or the marketing campaign.

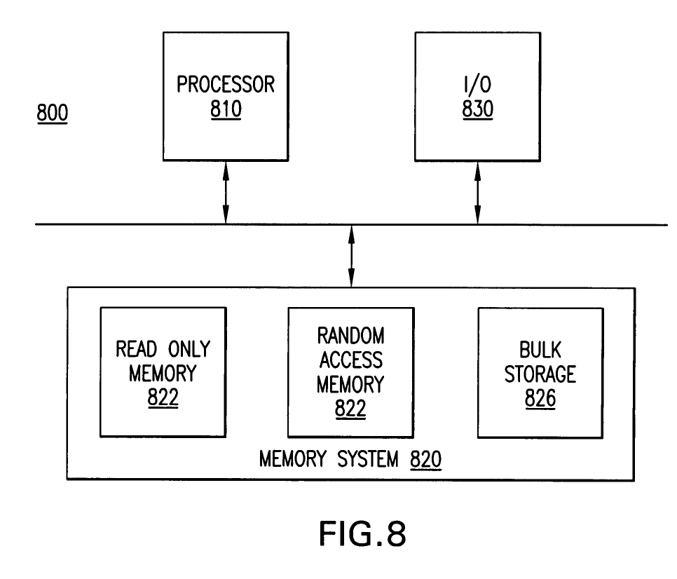

FIG. 8 is a block diagram illustrating the platform on which the method and system for an enhanced subscription capability for a newsletter using a publisher's network site may operate according to one embodiment of the present invention. Functionality of the foregoing embodiments may be provided on various computer platforms executing program instructions. One such platform 800 is illustrated in the simplified block diagram of FIG. 8. There, the platform 800 is shown as being populated by a processor 810, a memory system 820 and an inputoutput (I/O) unit 830. The processor 810 may be any of a plurality of conventional processing systems, including microprocessors, digital signal processors and field programmable logic arrays. In some applications, it may be advantageous to provide multiple processors (not shown) in the platform 800. The processor(s) 810 execute program instructions stored in the memory system. The memory system 820 may include any combination of conventional memory circuits, including electrical, magnetic or optical memory systems. As shown in FIG. 8, the memory system may include read only memories 822, random access memories 824, and bulk storage 826. The memory system not only stores the program instructions representing the various methods described herein but also can store the data items on which these methods operate. The I/O unit 830 would permit communication with external devices (not shown).

What is claimed is:

1. A method for implementing an enhanced subscription capability for a newsletter using a newsletter subscription and dissemination system, comprising:
targeting a business partner as a function of a business partner data item maintained by a publisher as part of the newsletter subscription and dissemination system;
displaying a link to the targeted business partner in a notification, wherein the notification informs the business partner about the newsletter and the notification presents the link to the business partner to facilitate at least one of subscribing to and unsubscribing from the newsletter;
initiating a newsletter subscription process as a function of the business partner selecting the link, wherein the newsletter subscription process allows the business partner to at least one of subscribe to and unsubscribe from the newsletter and the newsletter subscription process is initiated by navigating the business partner to at least one of a publisher network site and within the publisher network site; and
compiling a response statistic as a function of the targeted business partner initiating the newsletter subscription process.

2. The method according to claim 1, further comprising:
subscribing the targeted business partner to the newsletter as a function of the business partner initiating the newsletter subscription process.

3. The method according to claim 1, further comprising:
unsubscribing the targeted business partner from the newsletter as a function of the business partner initiating the newsletter subscription process.

4. The method according to claim 1, wherein the business partner data item is stored in a customer relationship management system as part of the newsletter subscription and dissemination system.

5. The method according to claim 4, wherein the response statistic is stored in the customer relationship management system.

6. The method according to claim 1, wherein the link is displayed to the targeted business partner in an email message.

7. The method according to claim 1, wherein the link is displayed to the targeted business partner on the publisher network site.

8. The method according to claim 1, wherein the business partner selects the link by clicking a pointing device while a cursor is over the displayed link.

9. A method for implementing an enhanced network-based marketing campaign using a newsletter subscription and dissemination system, comprising:
targeting a business partner as a function of the marketing campaign, wherein the business partner is selected for the marketing campaign as a function of a business partner data item maintained by a publisher as part of the newsletter subscription and dissemination system;
embedding a marketing campaign data item in a link for the targeted business partner, wherein the link is provided to at least one of allow the business partner to subscribe to a newsletter, to allow the business partner to unsubscribe from the newsletter, and to collect a response statistic measuring a response of the business partner to the marketing campaign;
displaying the link to the business partner in a notification, wherein the notification informs the business partner about the newsletter and the notification presents the link to the business partner to facilitate at least one of subscribing to and unsubscribing from the newsletter;
initiating a newsletter subscription process as a function of the business partner selecting the link, wherein the newsletter subscription process allows the business partner to at least one of subscribe to and unsubscribe from the newsletter and the newsletter subscription process is initiated by navigating the business partner to at least one of a publisher network site and within the publisher network site; and
compiling the response statistic as a function of the targeted business partner initiating the newsletter subscription process and as a function of the marketing campaign data item.

10. The method according to claim 9, further comprising:
subscribing the targeted business partner to the newsletter as a function of the business partner initiating the newsletter subscription process.

11. The method according to claim 9, further comprising:
unsubscribing the targeted business partner from the newsletter as a function of the business partner initiating the newsletter subscription process.

12. The method according to claim 9, wherein the business partner data item is stored in a customer relationship management system as part of the newsletter subscription and dissemination system.

13. The method according to claim 12, wherein the response statistic is stored in the customer relationship management system.

14. The method according to claim 9, wherein the link is displayed to the targeted business partner in an email message.

15. The method according to claim 9, wherein the link is displayed to the targeted business partner on the publisher network site.

16. The method according to claim 9, wherein the business partner selects the link by clicking a pointing device while a cursor is over the displayed link.

17. A system for implementing an enhanced subscription capability for a newsletter, comprising:
a program memory;
a storage device; and
a processor, wherein the processor is adapted to:
(i) target a business partner as a function of a business partner data item maintained by a publisher as part of the newsletter subscription and dissemination system;
(ii) display a link to the targeted business partner in a notification, wherein the notification informs the business partner about the newsletter and the notification presents the link to the business partner to facilitate at least one of subscribing to and unsubscribing from the newsletter;
(iii) initiate a newsletter subscription process as a function of the business partner selecting the link, wherein the newsletter subscription process allows the business partner to at least one of subscribe to and unsubscribe from the newsletter and the newsletter subscription process is initiated by navigating the business partner to at least one of a publisher network site and within the publisher network site; and
(iv) compile a response statistic as a function of the targeted business partner initiating the newsletter subscription process.

18. A system for implementing an enhanced network-based marketing campaign, comprising:
a program memory;
a storage device; and
a processor, wherein the processor is adapted to:
(i) target a business partner as a function of the marketing campaign, wherein the business partner is selected for the marketing campaign as a function of a business partner data item maintained by a publisher as part of the newsletter subscription and dissemination system;
(ii) embed a marketing campaign data item in a link for the ta rgeted business partner, wherein the link is provided to at least one of allow the business partner to subscribe to a newsletter, to allow the business partner to unsubscribe from the newsletter, and to collect a response statistic measuring a response of the business partner to the marketing campaign;
(iii) display the link to the business partner in a notification, wherein the notification informs the business partner about the newsletter and the notification presents the link to the business partner to facilitate at least one of subscribing to and unsubscribing from the newsletter;
(iv) initiate a newsletter subscription process as a function of the business partner selecting the link, wherein the newsletter subscription process allows the business partner to at least one of subscribe to and unsubscribe from the newsletter and the newsletter subscription process is initiated by navigating the business partner to at least one of a publisher network site and within the publisher network site; and
(v) compile the response statistic as a function of the targeted business partner initiating the newsletter subscription process and as a function of the marketing campaign data item.

19. A computer readable medium including instructions adapted to execute a method for implementing an enhanced subscription capability for a newsletter using a newsletter subscription and dissemination system, the method comprising:
targeting a business partner as a function of a business partner data item maintained by a publisher as part of the newsletter subscription and dissemination system;
displaying a link to the targeted business partner in a notification, wherein the notification informs the business partner about the newsletter and the notification presents the link to the business partner to facilitate at least one of subscribing to and unsubscribing from the newsletter;
initiating a newsletter subscription process as a function of the business partner selecting the link, wherein the newsletter subscription process allows the business partner to at least one of subscribe to and unsubscribe from the newsletter and the newsletter subscription process is initiated by navigating the business partner to at least one of a publisher network site and within the publisher network site; and
compiling a response statistic as a function of the targeted business partner initiating the newsletter subscription process.

20. A computer readable medium including instructions adapted to execute a method for implementing an enhanced network-based marketing campaign using a newsletter subscription and dissemination system, the method comprising:
targeting a business partner as a function of the marketing campaign, wherein the business partner is selected for the marketing campaign as a function of a business partner data item maintained by a publisher as part of the newsletter subscription and dissemination system;
embedding a marketing campaign data item in a link for the targeted business partner, wherein the link is provided to at least one of allow the business partner to subscribe to a newsletter, to allow the business partner to unsubscribe from the newsletter, and to collect a response statistic measuring a response of the business partner to the marketing campaign;
displaying the link to the business partner in a notification, wherein the notification informs the business partner about the newsletter and the notification presents the link to the business partner to facilitate at least one of subscribing to and unsubscribing from the newsletter;
initiating a newsletter subscription process as a function of the business partner selecting the link, wherein the newsletter subscription process allows the business partner to at least one of subscribe to and unsubscribe from the newsletter and the newsletter subscription process is initiated by navigating the business partner to at least one of a publisher network site and within the publisher network site; and
compiling the response statistic as a function of the targeted business partner initiating the newsletter subscription process and as a function of the marketing campaign data item.
